(19) United States
(12) Patent Application Publication
(10) Pub. No.: US 2025/0337801 A1
(43) Pub. Date: Oct. 30, 2025

(54) COMMUNICATION TERMINAL, NON-TRANSITORY COMPUTER-READABLE MEDIUM, TELECONFERENCE METHOD, TELECONFERENCE SYSTEM, AND SERVER

(71) Applicant: SHARP KABUSHIKI KAISHA, Osaka (JP)

(72) Inventor: YOSUKE OSAKI, Osaka (JP)

(21) Appl. No.: 19/184,296

(22) Filed: Apr. 21, 2025

(30) Foreign Application Priority Data
Apr. 26, 2024 (JP) 2024-072310

(51) Int. Cl. H04L 65/403; H04L 65/401

(52) U.S. Cl. CPC H04L 65/403; H04L 65/401

(57) ABSTRACT

A communication terminal that is provided at one site of a plurality of sites between which a teleconference is performed and communicates with another site via an external device comprises: an acquirer that acquires a video at the one site during the teleconference; a determiner that determines whether the video acquired contains a predetermined subject; and an outputter that performs a first output process of outputting a first video portion to the external device when the video is determined to contain the predetermined subject, the first video portion being obtained by removing a portion of the predetermined subject from the video.

### CROSS-REFERENCE TO RELATED APPLICATION

The present application claims priority from Japanese Application JP2024-72310, the content to which is hereby incorporated by reference into this application.

### BACKGROUND

### 1. Field of the Invention

The present disclosure relates to a communications terminal, a non-transitory computer-readable medium, a teleconference method, a teleconference system, and a server.

### 2. Description of the Related Art

In recent years, teleconference systems via a communication line have been increasingly utilized, and measures for preventing leakage of confidential information are also required in teleconferences. For example, a teleconference system having a viewing function of sharing content such as a document with a communication partner has been developed. In this teleconference system, viewing of content is restricted in accordance with participants in the teleconference.

### SUMMARY

In a teleconference system, a communication terminal provided at each of different sites transmits a video and audio of the site of the communication terminal to another site. The video may contain a subject captured which is not desired to be shown to a communication partner, such as confidential information. When the video is transmitted as-is, the confidential information or the like is at risk of unintentionally being known by the communication partner, and thus security enhancement is required for the video to be transmitted.

An object of the present disclosure is to provide a technique capable of enhancing security in a teleconference.

A communication terminal according to the present disclosure is provided at one site of a plurality of sites between which a teleconference is performed and communicates with another site via an external device. The communication terminal includes an acquirer, a determiner, and an outputter. The acquirer acquires a video at the one site during the teleconference. The determiner determines whether the video acquired contains a predetermined subject. The outputter performs a first output process of outputting a first video portion to the external device when the video is determined to contain the predetermined subject, the first video portion being obtained by removing a portion of the predetermined subject from the video.

A non-transitory computer-readable medium according to the present disclosure causes a computer of a communication terminal to execute processing, the communication terminal being provided at one site of a plurality of sites between which a teleconference is performed and communicating with another site via an external device. The processing includes acquiring a video at the one site during the teleconference, determining whether the video acquired contains a predetermined subject, and outputting a video portion to the external device when the video is determined to contain the predetermined subject, the video portion being obtained by removing a portion of the predetermined subject from the video.

A teleconference method according to the present disclosure uses a communication terminal, the communication terminal being provided at one site of a plurality of sites between which a teleconference is performed and communicating with another site via an external device. The teleconference method includes acquiring a video at the one site during the teleconference, determining whether the video acquired contains a predetermined subject, and outputting a video portion to the external device when the video is determined to contain the predetermined subject, the video portion being obtained by removing a portion of the predetermined subject from the video.

A teleconference system according to the present disclosure includes a communication terminal and an external device, the communication terminal being provided at one site of a plurality of sites between which a teleconference is performed and communicates with another site via the external device. The communication terminal includes an acquirer, a determiner, and an outputter. The acquirer acquires a video at the one site during the teleconference. The determiner determines whether the video acquired contains a predetermined subject. The outputter outputs a video portion to the external device when the video is determined to contain the predetermined subject, the video portion being obtained by removing a portion of the predetermined subject from the video. The external device acquires the video portion from the communication terminal and transmits the acquired video portion to the other site.

A server according to the present disclosure communicates with a plurality of communication terminals provided at a plurality of sites between which a teleconference is performed. The server includes an acquirer and a transmitter. The acquirer acquires videos at the plurality of sites during the teleconference. The transmitter transmits, when the acquired videos at the plurality of sites include a video at a site containing a predetermined subject, a video portion to other sites than the site, the video portion being obtained by removing a portion of the predetermined subject from the video at the site.

According to the present disclosure, information security in teleconference can be enhanced.

### BRIEF DESCRIPTION OF THE DRAWINGS

FIG. 1 is an overall configuration diagram of a teleconference system according to an embodiment.

FIG. 2 is a block diagram illustrating a schematic configuration of a communication terminal illustrated in FIG. 1.

FIG. 3 is a schematic diagram illustrating an example of a video during a teleconference.

FIG. 4 is an image diagram of output video data based on the video illustrated in FIG. 3.

FIG. 5 is a block diagram illustrating a schematic configuration of a server illustrated in FIG. 1.

FIG. 6 is an operation flow diagram illustrating operations of the teleconference system.

### DETAILED DESCRIPTION OF THE INVENTION

Hereinafter, a teleconference system according to an embodiment is described with reference to the drawings. In the drawings, the same or equivalent components are denoted by the same reference numerals and signs, and descriptions thereof are not repeated.

### Configuration

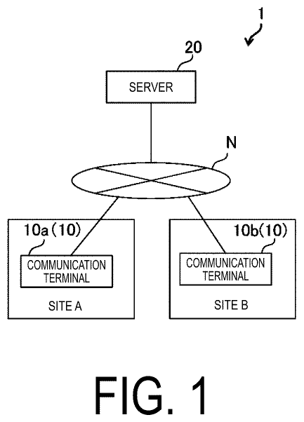

FIG. 1 is an overall configuration diagram of a teleconference system according to the present embodiment. As illustrated in FIG. 1, a teleconference system 1 includes communication terminals 10a (10) and 10b (10) provided at two sites A and B, respectively, that perform a teleconference, and a server 20. Hereinafter, when the communication terminals 10a and 10b are not distinguished from each other, they may be referred to as the communication terminals 10, and when the sites A and B are not distinguished from each other, they may be referred to as the sites. The number of sites at which the teleconference is performed may be three or more, and the communication terminal 10 may be provided at each site.

Each communication terminal 10 and the server 20 are connected to a communication network N such as the Internet. Participants (not illustrated) of the teleconference at each of the sites A and B use the communication terminals 10a and 10b, respectively, to perform the teleconference by exchanging videos and audios of the respective sites via the server 20. Each configuration is specifically described below.

### Communication Terminal 10

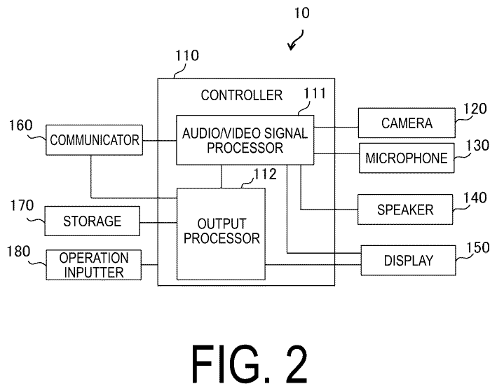

FIG. 2 is a block diagram illustrating a schematic configuration of the communication terminal 10 illustrated in FIG. 1. As illustrated in FIG. 2, the communication terminal 10 includes a controller 110, a camera 120, a microphone 130, a speaker 140, a display 150, a communicator 160, a storage 170, and an operation inputter 180.

The camera 120 captures a video at the site during the teleconference and outputs the captured video to the controller 110.

The microphone 130 collects audio at the site during the teleconference and outputs the collected audio to the controller 110.

The speaker 140 outputs audio of another site under the control of the controller 110.

The display 150 includes, for example, a liquid crystal display, and displays a video or the like at each site during the teleconference under the control of the controller 110.

The communicator 160 is a communication interface that communicates with the server 20 (FIG. 1). Specifically, the communicator 160 establishes communication with the server 20 using a communication protocol such as a real-time transport protocol (RTP), and transmits and receives video data and audio data.

The storage 170 includes a non-volatile storage medium such as a hard disk. The storage 170 stores programs such as a teleconference application program (hereinafter, referred to as a teleconference application) for participating in a teleconference, various types of image data related to the teleconference application, and the like.

The operation inputter 180 includes, for example, a keyboard, a mouse, and a touch panel. The operation inputter 180 receives an operation from a participant and outputs information indicating the received operation to the controller 110.

The controller 110 includes a central processing unit (CPU), a memory (read only memory (ROM)), and a random access memory (RAM) (not illustrated). When the CPU executes the teleconference application stored in the storage 170, the controller 110 functions as an audio/video signal processor 111 and an output processor 112.

The audio/video signal processor 111 includes a CODEC. The audio/video signal processor 111 sequentially transmits and receives packets of video data and audio data during the teleconference to and from the server 20 via the communicator 160.

Specifically, the audio/video signal processor 111 converts an audio signal input at certain time intervals from the microphone 130 and a video signal input at certain time intervals from the camera 120 into digital data in accordance with specifications of the teleconference system. The audio/video signal processor 111 outputs the digital data (audio data and video data) to the output processor 112.

The audio/video signal processor 111 decodes video data and audio data from the server 20 which are sequentially input from the communicator 160 according to the specifications of the teleconference system. The video data and the audio data from the server 20 are multiplexed with video data and audio data output from another communication terminal 10. The audio/video signal processor 111 decodes the video data and the audio data from the server 20, causes the display 150 to display video based on the decoded video data, and causes the speaker 140 to output audio based on the decoded audio data.

The output processor 112 acquires video data and audio data of the site where the output processor 112 itself is used from the audio/video signal processor 111. When a predetermined subject is contained in the acquired video data of the site where the output processor 112 itself is used, the output processor 112 outputs a video portion (an example of a first video portion) obtained by removing the predetermined subject from the acquired video data (an example of a first output process). The predetermined subject is, for example, an object to be concealed in which confidential information or the like is represented.

Specifically, the output processor 112 performs image analysis on the acquired video data, and generates output video data based on a result of the image analysis. Then, the output processor 112 performs processing such as coding on the output video data and the audio data, outputs the processed data from the communicator 160 to the server 20, and causes the display 150 to display the resulting acquired video data of the site where the output processor 112 itself is used. More specifically, the output processor 112 encodes the output video data using a predetermined video codec such as H.264, and encodes the audio data using an audio codec such as advanced audio coding (AAC). The output processor 112 adds a time stamp to each of the encoded output video data and audio data, divides the data into packets, and causes the communicator 160 to output the packets to the server 20.

The image analysis includes a first identifying process of identifying a person region in the video data and a second identifying process of identifying a region (hereinafter referred to as a concealment region) of a predetermined subject to be concealed (hereinafter referred to as a concealment target) in the video data. The person region is a region containing a face portion of a person. The concealment target may include, for example, a document, whiteboard writing, a display on which an image is displayed, and the like. In the image analysis, for example, a trained model may be used which is obtained by machine learning using training data with teaching data as an image of a person or an object of a concealment target. In the image analysis, for example, a technique such as a convolutional neural network or object detection may be used as artificial intelligence for recognizing a person or a concealment target.

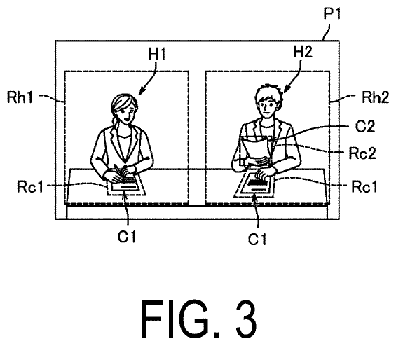

FIG. 3 is a schematic diagram illustrating an example of a video during a teleconference. A video P1 captured at the site of capturing during the teleconference illustrated in FIG. 3 contains participants H1 and H2 in the teleconference, and concealment targets C1 and C2. The concealment targets C1 and C2 are documents. In this case, the output processor 112 performs the first identifying process to identify, in the video P1, person regions Rh1 and Rh2 (examples of a second video portion) each having a predetermined size and containing the participants H1 and H2, respectively. The output processor 112 performs the second identifying process to identify concealment regions Rc1 and Rc2 in the video P1.

When the person region contains the concealment region, the output processor 112 generates the output video data from a video portion (an example of the first video portion) obtained by removing the concealment region (Rc1, Rc2) from the person region (Rh1, Rh2) and transmits the output video data to the server 20 (an example of the first output process).

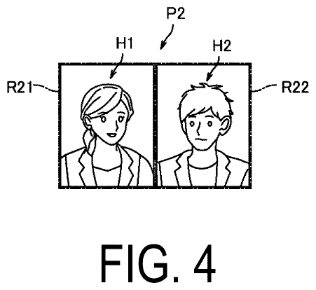

FIG. 4 is an image diagram of output video data based on the video illustrated in FIG. 3. Output video data P2 contains output videos R21 and R22. The output video R21 is a video obtained by removing the concealment region Rc1 from the person region Rh1 illustrated in FIG. 3 and enlarging the resultant video to a predetermined size. The output video R22 is a video obtained by removing the concealment regions Rc1 and Rc2 from the person region Rh2 illustrated in FIG. 3 and enlarging the resulting video to a predetermined size.

Note that when a person is not captured in a video and a concealment target is captured in the video, the output processor 112 removes a concealment region from the video to obtain a video portion and adjusts the video portion to a predetermined size to generate output video data. When a person region contains no concealment target, the output processor 112 generates output video data by adjusting a video portion of the person region to a predetermined size. When a video contains neither a person nor a concealment target, the output processor 112 generates output video data by adjusting the video to a predetermined size.

In the present embodiment, the output processor 112 is an example of an acquirer, a determiner, an outputter, and an identifier.

### Server 20

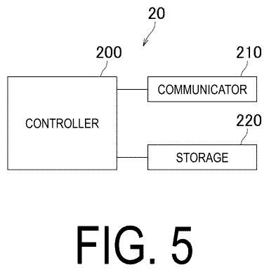

FIG. 5 is a block diagram illustrating a schematic configuration of the server 20 illustrated in FIG. 1. As illustrated in FIG. 5, the server 20 includes a controller 200, a communicator 210, and a storage 220.

The communicator 210 is a communication interface for communicating with the communication terminal 10 (FIG. 1 or FIG. 2). The communicator 210 establishes communication with the communication terminal 10 using a predetermined communication protocol such as the RTP under the control of the controller 200, and transmits and receives video data and audio data.

The storage 220 includes a non-volatile storage medium such as a hard disk. The storage 220 stores an application program of the teleconference system and terminal information (not illustrated) including identification information (such as an IP address) of the communication terminal 10.

The controller 200 includes a CPU and memories (ROM and RAM). When the CPU executes an application program stored in the ROM, the controller 200 communicates with each communication terminal 10 via the communicator 210. Specifically, the controller 200 acquires packets of audio data and video data transmitted from the communication terminal 10, and transmits data obtained by multiplexing the acquired audio data and video data according to the communication protocol such as the RTP to another communication terminal 10 based on the terminal information stored in the storage 220.

### Operation

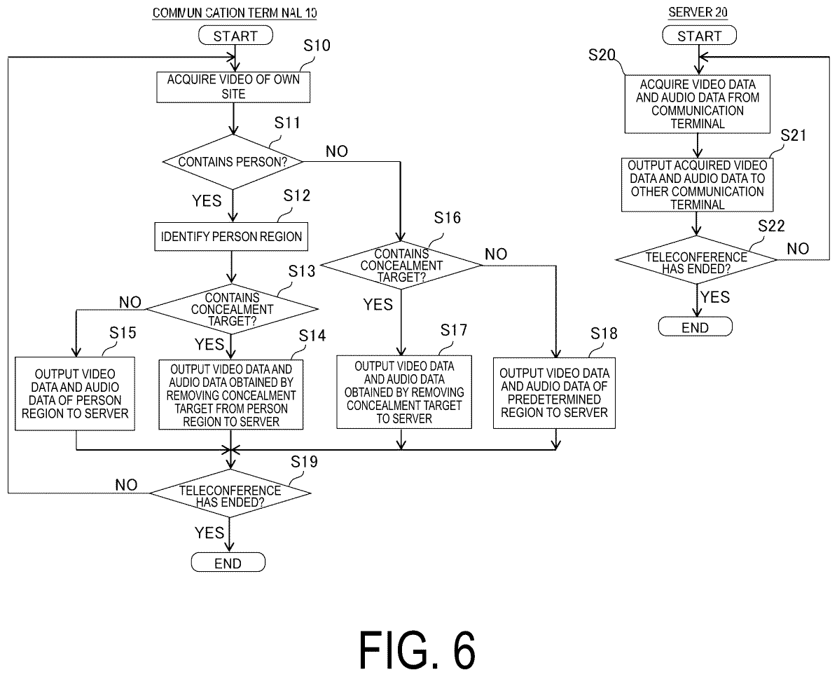

FIG. 6 is an operation flow diagram illustrating operations of the teleconference system 1. In FIG. 6, the communication terminal 10 is in a state in which the teleconference application is activated by the participant. In the following description, assume that the communication terminal 10 in FIG. 6 is provided at the site A, for example.

The communication station 10a acquires a video and audio of the site where communication station 10a is used (hereinafter, the site A) (step S10). Specifically, the audio/video signal processor 111 sequentially acquires signals of the video of the site A captured by the camera 120 and the audio collected by the microphone 130, and outputs video data and audio data obtained by digitally converting the acquired signals to the output processor 112.

The communication terminal 10a detects whether the acquired video contains a person (step S11). Specifically, the output processor 112 performs the first identifying process on the video data input from the audio/video signal processor 111 to perform predetermined image analysis for detecting a person on the video data, and detects whether the video data contains a person.

When the communication terminal 10a detects that the video data contains a person (step S11: YES), the communication terminal 10a identifies a person region in the video data (step S12). Specifically, the output processor 112 identifies a region having a predetermined size and containing a face of the person identified through the first identifying process as the person region in the video data.

The communication terminal 10a detects whether the identified person region contains a concealment target (step S13). Specifically, the output processor 112 performs the second identifying process to perform predetermined image analysis for detecting a concealment target on the person region, and detects whether the person region contains a concealment target.

When the communication terminal 10a detects that the person region contains a concealment target (step S13: YES), the communication terminal 10a outputs the video data in which the concealment target is removed from the person region and the audio data to the server 20 (step S14). Specifically, the output processor 112 removes the concealment region identified through the second identifying process from the person region to obtain data of a video portion and adjusts the data to a predetermined size to generate output video data. The output processor 112 performs processing such as coding on each of the output video data and the audio data, and transmits the processed data to the server 20 via the communicator 160.

In step S13, when the communication terminal 10a detects that the person region does not contain a concealment target (step S13: NO), the communication terminal 10a outputs the video of the person region and the audio data to the server 20 (step S15). Specifically, the output processor 112 adjusts the person region in the video data identified through the first identifying process to a predetermined size to generate output video data. The output processor 112 performs predetermined processing such as coding on each of the output video data and the audio data, and transmits the processed data to the server 20 via the communicator 160.

In step S11, when the communication terminal 10a detects that the acquired video data does not contain a person (step S11: NO), the communication terminal 10a detects whether the video data contains a concealment target (step S16). Specifically, the output processor 112 performs the second identifying process to perform predetermined image analysis for detecting a concealment target in the video data acquired from the audio/video signal processor 111, and detects whether the video data contains a concealment target.

When the communication terminal 10a detects that the acquired video data contains a concealment target (step S16: YES), the communication terminal 10a outputs the video data from which the concealment target is removed and the audio data to the server 20 (step S17). Specifically, the output processor 112 identifies the concealment region in the video data through the second identifying process and removes the concealment region from the video data to obtain a video portion, and adjusts the video portion to a predetermined size to generate output video data. The output processor 112 performs processing such as coding on each of the output video data and the audio data, and transmits the processed data to the server 20 via the communicator 160.

In step S16, when the communication terminal 10a detects that the acquired video data does not contain a concealment target (step S16: NO), the communication terminal 10a outputs the video of a predetermined region and the audio data to the server 20 (step S18). Specifically, when a concealment region cannot be identified from the video data through the second identifying process, the output processor 112 adjusts the acquired video data to a predetermined size to generate output video data. The output processor 112 performs processing such as coding on each of the output video data and the audio data, and transmits the processed data to the server 20 via the communicator 160.

The communication terminal 10a repeats the processing of step S10 and subsequent steps until receiving an operation to end the teleconference via the operation inputter 180 (step S19: NO). The communication terminal 10a, upon receiving the operation to end the teleconference via the operation inputter 180 (step S19: YES), ends the teleconference processing. For example, the communication terminal 10a, when receiving an operation to end the teleconference application, transmits information indicating the end of the communication to the server 20 via the communicator 160, and ends a screen of the teleconference application on the display 150.

The server 20 acquires the video data and the audio data from the communication terminal 10a (step S20). Specifically, the controller 200 acquires the packets of the output video data and the audio data output from the communication terminal 10a via the communicator 210.

The server 20 outputs the acquired video data and audio data to the other communication terminal 10b (step S21). Specifically, the controller 200 multiplexes the packets of the output video data and the audio data acquired from the communication terminal 10a in accordance with the communication protocol such as the RTP, and transmits the multiplexed packets to the other communication terminal 10b via the communicator 210.

The server 20 repeats the processing of step S22 and subsequent steps until the teleconference is ended in the communication terminal 10 (step S20: NO), and ends the communication with the communication terminal 10 when the teleconference is ended in the communication terminal 10 (step S22: YES). Specifically, the server 20 receives a signal indicating the end of the communication from the communication terminal 10 and ends the communication with the communication terminal 10.

Note that although not illustrated in the drawing, the communication station 10b provided in the other site (site B), when acquiring the output video data and the audio data from the server 20, decodes the acquired output video data and audio data using predetermined video and audio codecs by the audio/video signal processor 111, and outputs the decoded video data and audio data from the display 150 and the speaker 140, respectively.

In the above-described embodiment, when the concealment target is contained in the video at the site where the communication terminal 10 is installed during the teleconference, the video portion obtained by removing the concealment target from the video is transmitted to the other communication terminal 10 via the server 20. Therefore, compared to a case where the video containing the concealment target is transmitted from the server 20 to the communication partner, unintended leakage of the concealment information is prevented, and security is enhanced.

The embodiments of the disclosure have been described above. However, the disclosure is not limited to the above-described embodiments, and can be implemented in various forms without departing from the gist of the disclosure. In order to facilitate understanding, the drawings are illustrated schematically, focusing on the respective constituent elements, and thicknesses, lengths, numbers, and the like of the illustrated constituent elements are different from actual ones for convenience of creating drawings. In addition, the shapes, the dimensions, and the like of the respective constituent elements illustrated in the above-described embodiments are merely examples and are not particularly limited, and various changes can be made without substantially departing from the advantageous effects of the disclosure.

### Variations

(1) In the above embodiment, the communication terminal 10 may perform the image analysis to determine presence or absence of the concealment target based on the identification information identifying the participant in the teleconference. The identification information is, for example, a name and an affiliation of the participant. Note that the domain included in a mail address of the participant may be used as the identification information indicating the affiliation. The identification information may be stored in advance in the storage 170 or may be acquired from the server 20 or an external device via the communicator 160.

When the participants indicated by the identification information include a specific participant (for example, an outsider who does not belong to a predetermined affiliation), the communication terminal 10 performs the image analysis of the concealment target through the second identifying process to generate the output video data. When the participants indicated by the identification information do not include a specific participant, the communication terminal 10 generates the output video data without performing the second identifying process. That is, when the acquired identification information is identification information of a participant other than the specific participant, the communication terminal 10 outputs the video portion (an example of the second video portion) of the person region identified through the first identifying process to the server 20 (an example of a third output process).

(2) In the above-described embodiment, when a size of a region of the video portion (an example of the second video portion) obtained by removing the secret region from the person region is equal to or smaller than a threshold value, the communication terminal 10 may output an instruction to replace the output video data with another video to the server 20 (an example of a second output process).

The other video is an image from which the participant can be identified, and may be, for example, a face image of the participant photographed in advance, an icon image represented by an illustration or the like, and the sort of thing. The smaller the video portion obtained by removing the concealment target is, the higher an enlargement ratio of the video portion for adjustment to the predetermined size becomes, and the more likely a person portion is to become unclear. By replacing the output video data with another video, the communication partner can be easily identified.

(3) In the above-described embodiment, the communication terminal 10 performs the processing of performing the image analysis of the concealment target through the second identifying process and outputting the output video data not containing the concealment target to the server 20. However, the server 20 may generate the output video data and transmit the output video data to another communication terminal 10.

For example, the communication terminal 10 may perform only the first identifying process without performing the second identifying process on the video of the site where the communication terminal 10 itself is installed. In this case, the server 20 acquires the video data having a predetermined size and containing the person region from the communication terminal 10, performs the second identifying process on the acquired video data, and generates the output video data. Then, the server 20 transmits the output video data to the other communication terminal 10.

In addition, for example, the communication terminal 10 may output the video data having a predetermined size to the server 20 without performing any of the first identifying process and the second identifying process. In this case, the server 20 acquires the video data having the predetermined size output from the communication terminal 10, performs the first identifying process and the second identifying process on the acquired video data, generates the output video data having the predetermined size, and transmits the output video data to the other communication terminal 10. That is, the server 20 according to the present variation includes an acquirer that acquires video during a teleconference at each site, and a transmission unit that, when there is video including a predetermined subject in the acquired video at each site, transmits a video portion obtained by excluding a portion of the predetermined subject from the video at the site to another site other than the site.

(4) When a determination of YES is made in step S13 and step S16 in FIG. 6 in the above-described embodiment, that is, when the video or the person region contains the concealment target, communication terminal 10 may transmit information indicating that the predetermined subject is captured in the video from at least one of the speaker 140 and the display 150 (an example of an informer).

(5) Functional units (the audio/video signal processor 111 and the output processor 112) in the communication terminal 10 illustrated in the above-described embodiment may be individually integrated into one chip by a semiconductor device such as an LSI, or may be integrated into one chip to include some or all of the functional units.

A part or all of the processing of the functional units illustrated in the above-described embodiment may be executed by a program. Specifically, the processing of the output processor 112 in the above-described embodiment may be executed by a program. That is, the processing includes acquiring a video at the one site during the teleconference, determining whether the video acquired contains a predetermined subject, and outputting a video portion to the external device when the video is determined to contain the predetermined subject, the video portion being obtained by removing a portion of the predetermined subject from the video.

The processing of the functional units of the communication terminal 10 and the server 20 illustrated in the above-described embodiment may be performed by the following system. A system includes one or more processors, wherein the one or more processors acquire a video via a communication terminal at one site, determine whether the video acquired contains a predetermined subject, and transmits a video portion to another side when the video is determined to contain the predetermined subject, the video portion being obtained by removing a portion of the predetermined subject from the video.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A communication terminal that is provided at one site of a plurality of sites between which a teleconference is performed and communicates with another site via an external device, the communication terminal comprising:
an acquirer that acquires a video at the one site during the teleconference;
a determiner that determines whether the video acquired contains a predetermined subject; and
an outputter that performs a first output process of outputting a first video portion to the external device when the video is determined to contain the predetermined subject, the first video portion being obtained by removing a portion of the predetermined subject from the video.

2. The communication terminal according to claim 1, further comprising
an identifier that identifies a person portion from the video acquired, wherein
the determiner determines whether a second video portion, in the video, containing the person portion identified contains the predetermined subject.

3. The communication terminal according to claim 1, wherein
when a size of a region of the first video portion is equal to or smaller than a threshold value, the outputter performs a second output process of outputting an instruction to replace the first video portion with another video to the external device.

4. The communication terminal according to claim 1, further comprising:
an informer that transmits information indicating that the predetermined subject is captured in the video when the video is determined to contain the predetermined subject.

5. The communication terminal according to claim 2, wherein
the outputter acquires participant identification information identifying a participant participating in the teleconference at the other site, performs the first output process when the participant identification information acquired includes the participant identification information of a specific participant, and performs a third output process of outputting the second video portion to the external device when the participant identification information acquired is not the participant identification information of the specific participant.

6. A non-transitory computer-readable medium that causes a computer of a communication terminal to execute processing, the communication terminal being provided at one site of a plurality of sites between which a teleconference is performed and communicating with another site via an external device, the processing includes
acquiring a video at the one site during the teleconference,
determining whether the video acquired contains a predetermined subject, and
outputting a video portion to the external device when the video is determined to contain the predetermined subject, the video portion being obtained by removing a portion of the predetermined subject from the video.

7. A teleconference method using a communication terminal, the communication terminal being provided at one site of a plurality of sites between which a teleconference is performed and communicating with another site via an external device, the teleconference method comprising:
acquiring a video at the one site during the teleconference;
determining whether the video acquired contains a predetermined subject; and
outputting a video portion to the external device when the video is determined to contain the predetermined subject, the video portion being obtained by removing a portion of the predetermined subject from the video.

8. A teleconference system comprising a communication terminal and an external device, the communication terminal being provided at one site of a plurality of sites between which a teleconference is performed and communicates with another site via the external device, wherein
the communication terminal includes
an acquirer that acquires a video at the one site during the teleconference,
a determiner that determines whether the video acquired contains a predetermined subject, and
an outputter that outputs a video portion to the external device when the video is determined to contain the predetermined subject, the video portion being obtained by removing a portion of the predetermined subject from the video, and
the external device acquires the video portion from the communication terminal and transmits the acquired video portion to the other site.

9. A server that communicates with a plurality of communication terminals provided at a plurality of sites between which a teleconference is performed, the server comprising:
an acquirer that acquires videos at the plurality of sites during the teleconference; and
a transmitter that transmits, when the acquired videos at the plurality of sites include a specific video at a specific site of the plurality of sites containing a predetermined subject, a video portion to other sites than the specific site, the video portion being obtained by removing a portion of the predetermined subject from the video at the site.
